(19) United States
(12) Patent Application Publication
(10) Pub. No.: US 2014/0340909 A1
(43) Pub. Date: Nov. 20, 2014

(54) LAMP UNIT AND LIGHT DEFLECTING DEVICE

(71) Applicant: KOITO MANUFACTURING CO., LTD., Tokyo (JP)

(72) Inventor: Takayuki YAGI, Shizuoka-shi (JP)

(73) Assignee: KOITO MANUFACTURING CO., LTD., Tokyo (JP)

(21) Appl. No.: 14/264,618

(22) Filed: Apr. 29, 2014

(30) Foreign Application Priority Data
May 7, 2013 (JP) 2013-097702

(51) Int. Cl. F21V 7/00; G02B 26/08; F21S 8/10

(52) U.S. Cl. CPC F21V 7/0025; F21S 48/1752; F21S 48/171; G02B 26/0816
USPC 362/297; 362/346

(57) ABSTRACT

A light deflecting device includes a micro-mirror array and a transparent cover member arranged in front of a micro-mirror array reflective surface. Each of a plurality of mirror elements of the micro-mirror array is selectively switched between a first reflecting position in which the mirror element reflects light such that the reflected light is effectively used as part of a predetermined light distribution pattern, and a second reflecting position in which the mirror element reflects light such that the reflected light is not effectively used. The cover member is configured such that a second angle formed between a mirror element reflective surface when the mirror element is in the second reflecting position and a cover member surface is smaller than a first angle formed between the mirror element reflective surface when the mirror element is in the first reflecting position and the cover member surface.

### INCORPORATION BY REFERENCE

The disclosure of Japanese Patent Application No. 2013-097702 filed on May 7, 2013 including the specification, drawings and abstract is incorporated herein by reference in its entirety.

### BACKGROUND OF THE INVENTION

1. Field of the Invention

The invention relates to a lamp unit and a light deflecting device used in a lamp unit.

2. Description of Related Art

Japanese Patent Application Publication No. 2004-210125 (JP 2004-210125 A) proposes a vehicle digital lighting device that illuminates a road surface or the like with a predetermined distribution pattern using a reflector type digital lighting device. This apparatus has multiple micro-mirror elements, each of which is tiltably arranged, and is configured to create a distribution pattern that illuminates a road surface of the like by digitally switching a tilt angle of the multiple micro-mirror elements between a first tilt angle and a second tilt angle, to appropriately change a reflective direction of light from a light source between a first reflective direction in an ON state and a second reflective direction in an OFF state.

However, with an apparatus such as that described above, there are cases in which a cover glass for protecting the multiple micro-mirror elements from the external environment is arranged in front of a reflective surface of the micro-mirror elements. Such a cover glass may reflect some of the light from the light source on a surface, and this reflected light may reach the lens as stray light.

### SUMMARY OF THE INVENTION

The invention thus provides a light unit and a light deflecting device capable of suppressing stray light from reflected light of a cover member surface of a light deflecting device.

A first aspect of the invention relates to a lamp unit that includes a projection optical system, and a light deflecting device that is arranged on an optical axis of the projection optical system, and that selectively reflects light emitted from a light source toward the projection optical system. The light deflecting device includes a micro-mirror array that includes a plurality of mirror elements, and a transparent cover member arranged in front of a reflective surface of the micro-mirror array. Each mirror element of the micro-mirror array is configured to be selectively switched between a first reflecting position in which the mirror element reflects the light emitted from the light source toward the projection optical system such that the reflected light is effectively used as part of a predetermined light distribution pattern, and a second reflecting position in which the mirror element reflects the light emitted from the light source such that the reflected light is not effectively used. The cover member is configured such that a second angle formed between a reflective surface of the mirror element when the mirror element is in the second reflecting position and a surface of the cover member is smaller than a first angle formed between the reflective surface of the mirror element when the mirror element is in the first reflecting position and the surface of the cover member.

According to this aspect, the second angle formed between the reflective surface of the mirror element when the mirror element is in the second reflecting position and the surface of the cover member is smaller than the first angle formed between the reflective surface of the mirror element when the mirror element is in the first reflecting position and the surface of the cover member, so the reflected light of the cover member tends to overlap with the reflected light from the surface of the mirror element in the second reflecting position that reflects light emitted from the light source such that the emitted light is not effectively used. That is, it is possible that the reflected light of the cover member is not effectively used.

A second aspect of the invention relates to a light deflecting device that includes a micro-mirror array that includes a plurality of mirror elements, and a transparent cover member arranged in front of a reflective surface of the micro-mirror array. Each mirror element of the micro-mirror array is configured to be selectively switched between a first reflecting position in which the mirror element reflects light emitted from a light source such that the reflected light is effectively used as part of a predetermined light distribution pattern, and a second reflecting position in which the mirror element reflects light emitted from the light source such that the reflected light is not effectively used. The cover member is configured such that a second angle formed between a reflective surface of the mirror element when the mirror element is in the second reflecting position and a surface of the cover member is smaller than a first angle formed between the reflective surface of the mirror element when the mirror element is in the first reflecting position and the surface of the cover member.

According to this aspect, the second angle formed between the reflective surface of the mirror element when the mirror element is in the second reflecting position and the surface of the cover member is smaller than the first angle formed between the reflective surface of the mirror element when the mirror element is in the first reflecting position and the surface of the cover member, so the reflected light of the cover member tends to overlap with the reflected light from the surface of the mirror element in the second reflecting position that reflects light emitted from the light source such that the emitted light is not effectively used. That is, it is possible that the reflected light of the cover member is not effectively used.

According to the invention, stray light due to reflected light of the surface of the cover member of the light deflecting device is able to be suppressed.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1A is a side view showing a frame format of the general structure of a lamp unit according to a first example embodiment of the invention, and FIG. 1B is a perspective view showing a frame format of the general structure of the lamp unit according to the first example embodiment;

FIG. 2A is a front view of the general structure of a light deflecting device according to a reference example, and FIG. 2B is a sectional view taken along line IIB-IIB of the light deflecting device shown in FIG. 2A;

FIG. 3A is a view showing a frame format of the spread of reflected light when a mirror element in a first reflecting position reflects light emitted from a light source, and

FIG. 3B is a view showing a frame format of the spread of reflected light when the mirror element in a second reflecting position reflects light emitted from the light source;

FIG. 4 is a view showing a frame format of the spread of reflected light when the spread of an incidence angle when the reflected light strikes a reflective surface of the mirror element is large;

FIG. 5 is a sectional view of the general structure of the light deflecting device according to the first example embodiment;

FIG. 6A is a view showing a frame format of the spread of reflected light when the mirror element in the first reflecting position reflects light emitted from the light source, in the light deflecting device according to the first example embodiment; and FIG. 6B is a view showing a frame format of the spread of reflected light when the mirror element in the second reflecting position reflects light emitted from the light source, in the light deflecting device according to the first example embodiment;

FIG. 7 is a side view of the general structure of a light deflecting device according to a second example embodiment of the invention;

FIG. 8 is a side view of the general structure of a light deflecting device according to a third example embodiment of the invention;

FIG. 9A is a side view of the general structure of a light deflecting device according to a fourth example embodiment of the invention, and FIG. 9B is a side view of the general structure of a light deflecting device according to a modified example of the fourth example embodiment; and

FIG. 10 is a view showing a frame format of a state in which light is radiated in front of a vehicle by a lamp unit provided with the light deflecting device according to the fourth example embodiment.

### DETAILED DESCRIPTION OF EMBODIMENTS

Hereinafter, example embodiments of the invention will be described with reference to the accompanying drawings. Like or equivalent constituent elements, members, and processes shown in the drawings will be referred to by like reference characters, and redundant descriptions thereof will be omitted as appropriate. Also, the example embodiments are only examples and are not intended to limit the invention. All of the characteristics and combinations thereof described in the example embodiments are not necessarily essential to the invention.

### First Example Embodiment

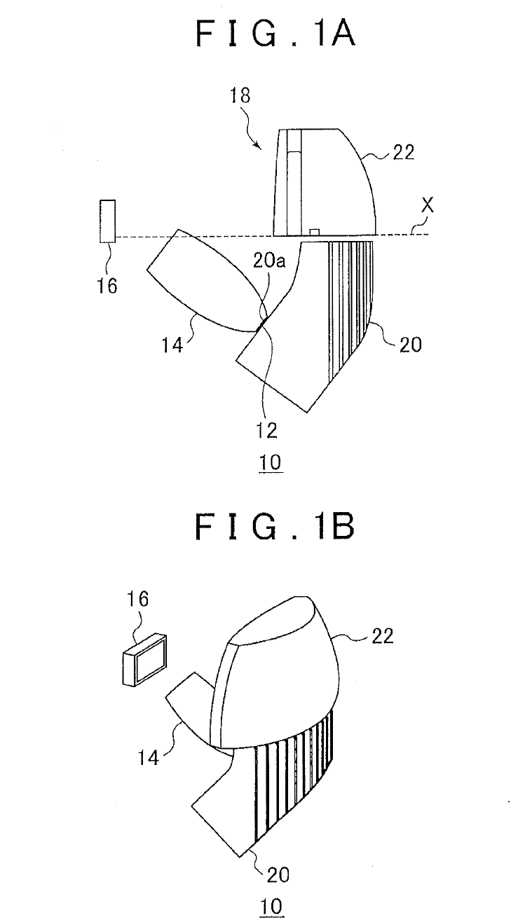

FIG. 1A is a side view showing a frame format of the general structure of a lamp unit according to a first example embodiment of the invention, and FIG. 1B is a perspective view showing a frame format of the general structure of the lamp unit according to the first example embodiment.

The lamp unit according to the first example embodiment is mainly used in a vehicular lamp (for example, a vehicular headlamp). However, the use is not limited to this. For example, the lamp unit may also be applied to a lamp of any of a variety of lighting devices or any of a variety of moving objects (such as an aircraft or a railcar). A lamp unit 10 includes a light source 12, a light condensing member 14, a light deflecting device 16, a projection optical system 18, and a heat dissipating member 20.

A semiconductor light emitting element such as an LED (Light Emitting Diode), LD (Laser Diode), or EL (Electro Luminescence) element, or a light bulb, an incandescent lamp (halogen lamp), or a discharge lamp or the like, may be used as the light source 12. The light condensing member 14 is configured to guide most of light emitted from the light source 12 to a reflective surface of the light deflecting device 16. A projectile-shaped solid light guide or a reflective mirror in which an inner surface is a predetermined reflective surface or the like may be used as the light condensing member 14, for example. A light condensing member does not have to be used when light emitted from the light source 12 is guided directly to the reflective surface of the light deflecting device 16.

The light deflecting device 16 is arranged on an optical axis X of the projection optical system 18, and is configured to selectively reflect light emitted from the light source 12 to the projection optical system 18. The light deflecting device 16 is a device in which a plurality of micro-mirrors are arranged in an array (a matrix), such as a MEMS (Micro Electra Mechanical System) or a DMD (Digital Mirror Device), for example. This light deflecting device 16 is able to selectively change the reflection direction of light emitted from the light source 12, by controlling the angles of the reflective surfaces of these micro-mirrors. That is, the light deflecting device 16 is able to reflect some of the light emitted from the light source 12 toward the projection optical system 18, and reflect the rest of the light in a direction in which the reflected light will not be used effectively. Here, the direction in which the reflected light will not be used effectively may be defined as a direction where the effect of reflected light is small (for example, a direction in which the reflected light will not contribute to creating a predetermined light distribution pattern), or a direction toward a light absorbing member (a light shielding member).

The projection optical system 18 according to this example embodiment includes a lens 22. Also, a micro-mirror array, which will be described later, of the light deflecting device 16 is arranged near the focal point of the lens 22. The optical member included in the projection optical system is not limited to the lens, but may also be a reflective member. The lens 22 has a half-bowl shape, with at least one of an incident surface and an emitting surface having a predetermined shape. Also, a portion of the lens 22 where light reflected by the light deflecting device 16 does not strike (i.e., a region on the upper side of the lens 22 in FIG. 1A) may be cut out in order to reduce the height of the overall lamp unit 10.

The heat dissipating member 20 is a heat sink made of metal or ceramic or the like, and has a light source mounting portion 20a to which the light source 12 is mounted. This light source mounting portion 20a is configured to be able to mount the light source 12 in a desirable position.

The lamp unit 10 structured as described above may be used in a variable light distribution headlamp that can be partially turned on and off.

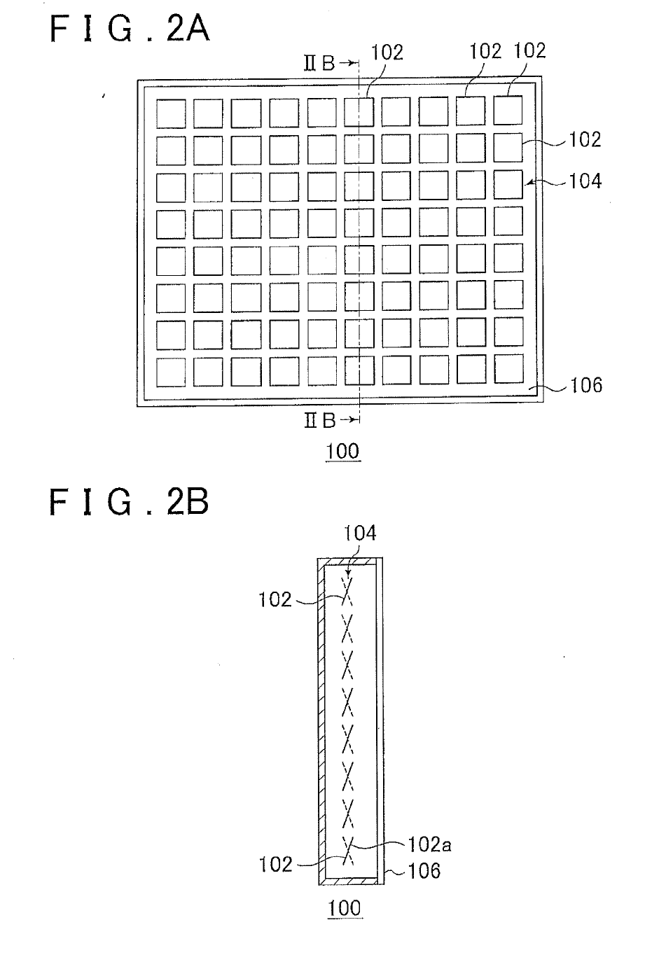

FIG. 2A is a front view of the general structure of a light deflecting device according to a reference example, and FIG. 2B is a sectional view taken along line IIB-IIB of the light deflecting device shown in FIG. 2A.

The light deflecting device 100 according to the reference example includes a micro-mirror array 104 in which a plurality of micro-mirror elements 102 are arranged in a matrix, and a transparent cover member 106 that is arranged in front of a reflective surface 102a of the mirror elements 102 (i.e., on the right side of the light deflecting device 100 shown in FIG. 2B). The cover member is made of glass or plastic or the like, for example. Here, the direction in which light reflected by the reflective surface 102a of the mirror elements 102 is directed from the light deflecting device 100 is the front.

Each mirror element 102 of the micro-mirror array 104 is configured to be selectively switched between a first reflecting position P1 (i.e., the position indicated by the solid line in FIG. 2B) in which the mirror element 102 reflects light emitted from the light source toward the projection optical system such that the reflected light is used effectively as part of a predetermined distribution pattern, and a second reflecting position P2 (i.e., the position indicated by the dotted line in FIG. 2B) in which the mirror element 102 reflects light emitted from the light source such that the reflected light is not used effectively.

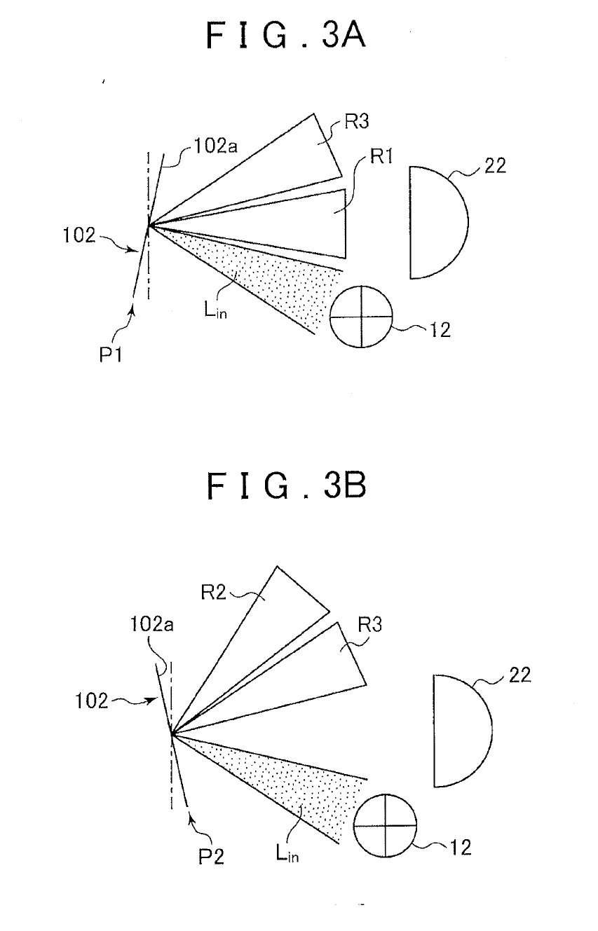

FIG. 3A is a view showing a frame format of the spread of reflected light when a mirror element in the first reflecting position reflects light emitted from the light source, and FIG. 3B is a view showing a frame format of the spread of reflected light when the mirror element in the second reflecting position reflects light emitted from the light source. In FIGS. 3A and 3B, a single mirror element is shown in place of the micro-mirror array to simplify the description.

As shown in FIG. 3A, the light emitted from the light source 12 is condensed by the light condensing member 14, so incident light Lᵢₙ will not be completely parallel light. That is, the incident light Lᵢₙ is such that an incidence angle when the light strikes the reflective surface 102a of the mirror element 102 has a certain amount of spread. Also, the mirror element 102 is arranged such that reflected light R1 mainly heads toward the lens 22 when the incident light Lᵢₙ is reflected by the mirror element 102 in the first reflecting position P1. Also, as shown in FIG. 3B, the mirror element 102 is arranged such that reflected light R2 does not head toward the lens 22 when the incident light Lᵢₙ is reflected by the mirror element 102 in the second reflecting position P2.

A predetermined projected image, reflected image, or light distribution pattern is able to be obtained by controlling the reflecting position of each mirror element 102 and selectively changing the reflection direction of light emitted from the light source 12. This kind of light deflecting device 100 is provided with the cover member 106, so there are cases in which some of the incident light Lᵢₙ is reflected by the cover member. The light reflected by the cover member does not reach the mirror element, so the reflection direction is unable to be selectively changed. That is, when the alternate long and short dash line shown in FIGS. 3A and 3B indicates the cover member, some of the incident light Lᵢₙ is reflected in a predetermined direction by the cover member 106 as reflected light R3, regardless of whether the mirror element 102 is in the first reflecting position P1 or the second reflecting position P2. Here, a case in which light is reflected by the cover member includes not only a case in which light is reflected by a surface of the cover member, but also a case in which light that strikes the cover member is internally reflected by a back surface of the cover member and emitted from the surface of the cover member again. Almost none of the reflected light R3 shown in FIGS. 3A and 3B heads toward the lens 22, so it will not affect the light distribution pattern.

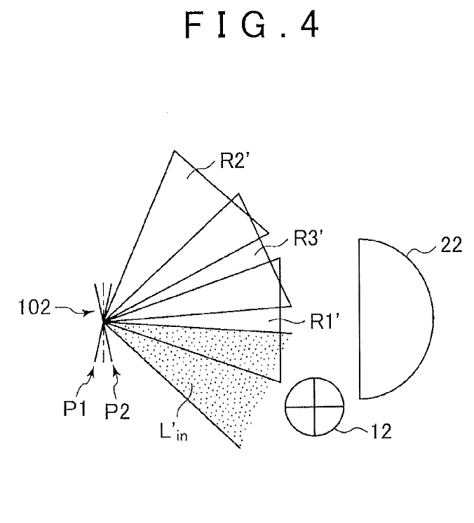

However, if a solid angle of an incident light flux onto the lens is increased in order to increase the amount of light of the lamp unit, some of the reflected light of the cover member may reach the lens and become stray light. FIG. 4 is a view showing a frame format of the spread of reflected light when the spread of an incidence angle when the reflected light strikes the reflective surface of the mirror elements is large.

As shown in FIG. 4, if the light emitted from the light source is condensed from a wider range in order to increase the utilization efficiency of light emitted from the light source, incident light L′ᵢₙ will be such that a range of the incidence angle when the light strikes the reflective surface 102a of the mirror element 102 will become even wider. Therefore, reflected light R1′ when the mirror element 102 in the first reflecting position P1 reflects the incident light L′ᵢₙ, reflected light R2′ when the mirror element 102 in the second reflecting position P2 reflects the incident light L′ᵢₙ, and reflected light R3′ when the surface of the cover member 106 reflects some of the incident light L′ᵢₙ widen to a wider range than the reflected light R1, R2, and R3, respectively, shown in FIGS. 3A and 3B.

Therefore, the reflected light R1′ that heads toward the projection optical system so as to be effectively used as part of the predetermined light distribution pattern overlaps with the reflected light R3′ that is reflected by the surface of the cover member 106, and some of the reflected light R3′ heads toward the lens 22. As a result, a region in the predetermined light distribution pattern where light should not be radiated becomes brighter, which is problematic.

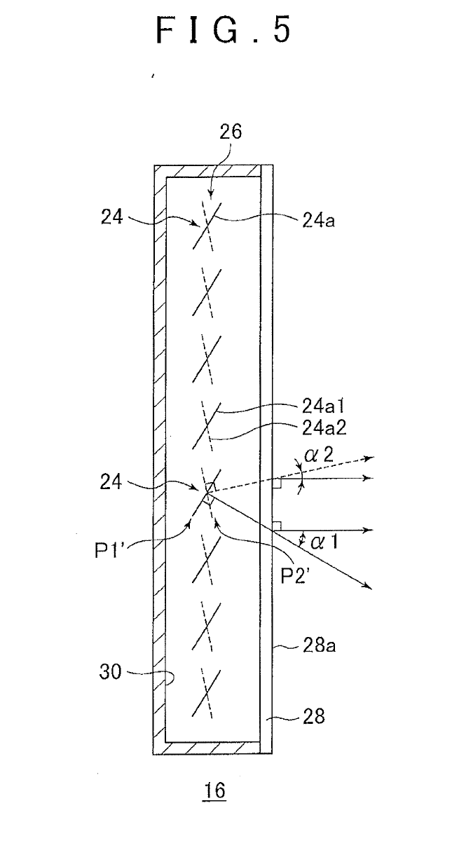

Therefore, in this example embodiment, the effect of this problem is reduced by changing the relationship between the position of the cover member of the micro-mirror array and the two reflecting positions of the reflective surface of the mirror element. FIG. 5 is a sectional view of the general structure of the light deflecting device according to the first example embodiment.

The light deflecting device 16 shown in FIG. 5 includes a micro-mirror array 26 in which a plurality of micro-mirror elements 24 are arranged in a matrix, and a transparent cover member 28 that is arranged in front of a reflective surface 24a of the mirror elements 24 (i.e., on the right side of the light deflecting device 16 shown in FIG. 5), similar to the light deflecting device 100 shown in FIG. 2B.

In the light deflecting device 16, the cover member 28 is configured such that a second angle α2 formed by a reflective surface 24a2 of the mirror element 24 when the mirror element 24 is in a second reflecting position P2′ and a surface 28a of the cover member 28 is smaller than a first angle α1 formed by a reflective surface 24a1 of the mirror element 24 when the mirror element 24 is in a first reflecting position P1′ and a surface 28a of the cover member 28.

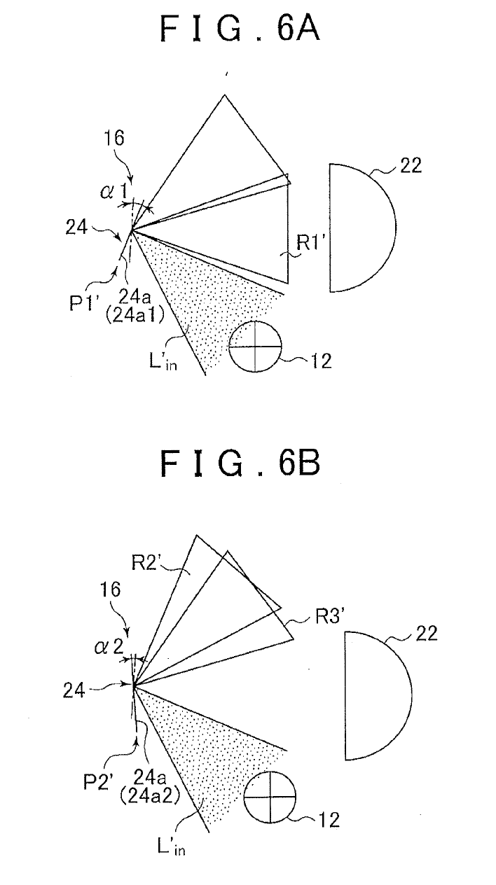

FIG. 6A is a view showing a frame format of the spread of reflected light when the mirror element in the first reflecting position reflects light emitted from the light source, in the light deflecting device 16 according to the first example embodiment, and FIG. 6B is a view showing a frame format of the spread of reflected light when the mirror element in the second reflecting position reflects light emitted from the light source, in the light deflecting device 16 according to the first example embodiment. In FIGS. 6A and 6B, a single mirror element is shown in place of the micro-mirror array to simplify the description.

As shown in FIG. 6A, if the light emitted from the light source is condensed from a wider range in order to increase the utilization efficiency of light emitted from the light source, the incident light L′ᵢₙ will be such that the range of the incidence angle when the light strikes the reflective surface 24a of the mirror element 24 will become even wider than it is in FIG. 3A. Also, the mirror element 24 is arranged such that reflected light R1′ mainly heads toward the lens 22 when the incident light L′ᵢₙ is reflected by the mirror element 24 in the first reflecting position P1′. As shown in FIG. 6B, the mirror element 24 is arranged such that the reflected light R2′ does not head toward the lens 22 when the incident light L′ᵢₙ is reflected by the mirror element 24 in the second reflecting position P2′.

In the lamp unit using the light deflecting device 16, the second angle α2 formed by the reflective surface 24a2 of the mirror element 24 when the mirror element 24 is in the second reflecting position P2′ and the surface of the cover member (indicated by the position of the alternate long and short dash line in FIG. 6B) is smaller than the first angle α1 formed by the reflective surface 24a1 of the mirror element 24 when the mirror element 24 is in the first reflecting position P1′ and the surface of the cover member (indicated by the position of the alternate long and short dash line in FIG. 6A), so the reflected light R3′ of the cover member largely overlaps with the reflected light R2′ from the mirror element 24 in the second reflecting position P2′ that reflects the light emitted from the light source so that it (i.e., the reflected light) is not used effectively. That is, the reflected light of the cover member may be directed away from the lens 22.

### Second Example Embodiment

With the light deflecting device 16 according to the first example embodiment, the array direction of the micro-mirror array 26 and the surface 28a of the cover member 28 are substantially parallel, as shown in FIG. 5. Therefore, the first reflecting position P1′ and the second reflecting position P2′ of the mirror element 24 are not symmetrical positions with respect to a parallel bottom surface 30 of the light deflecting device 16 on which the mirror element 24 is mounted. Therefore, the dedicated structure of the mirror element 24 may need to be designed in order that the two reflecting positions are asymmetrical with respect to the mounting surface, so the cost may increase compared to when a standard mirror element are used.

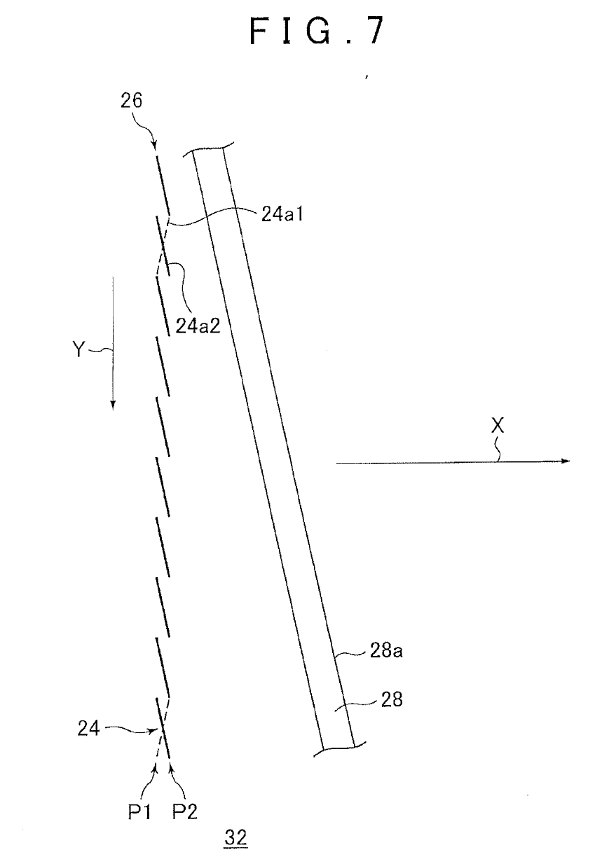

FIG. 7 is a side view of the general structure of a light deflecting device 32 according to a second example embodiment of the invention. The light deflecting device 32 according to this second example embodiment is configured such that the surface 28a of the cover member 28 is inclined with respect to an array direction Y of the micro-mirror array 26. When the array direction Y of the micro-mirror array 26 is perpendicular to an optical axis X, the surface 28a of the cover member 28 is arranged inclined with respect to this optical axis X.

As a result, even if the mirror element 24 is arranged such that the first reflecting position P1 and the second reflecting position P2 are symmetrical with respect to the array direction Y of the micro-mirror array 26, it is possible to make the second angle α2 formed by the reflective surface 24a2 of the mirror element 24 when the mirror element 24 is in the second reflecting position P2 and the surface 28a of the cover member 28 smaller than the first angle α1 formed by the reflective surface 24a1 of the mirror element 24 when the mirror element 24 is in the first reflecting position P1 and the surface 28a of the cover member 28. In particular, by making the reflective surface 24a2 of the mirror element 24 when the mirror element 24 is in the second reflecting position P2 and the surface 28a of the cover member 28 substantially parallel, the reflected light of the surface 28a of the cover member 28 is substantially aligned with the reflected light from the mirror element 24 in the second reflecting position P2, so stray light will not strike the lens.

### Third Example Embodiment

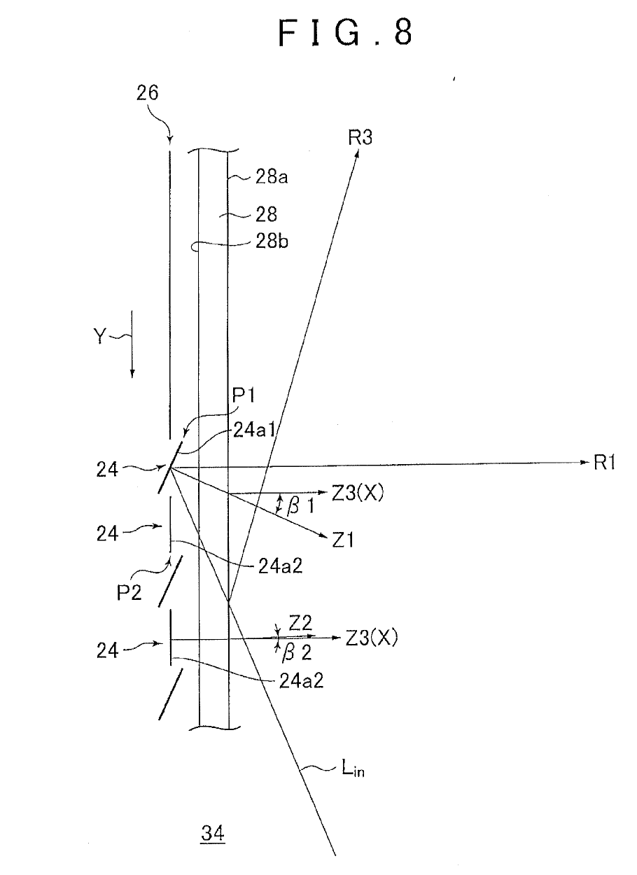

FIG. 8 is a side view of the general structure of a light deflecting device 34 according to a third example embodiment of the invention. With the light deflecting device 34, the array direction Y of the micro-mirror array 26 is parallel to the surface 28a of the cover member 28. Also, the reflective surface 24a1 of the mirror element 24 when the mirror element 24 is in the first reflecting position P1 is configured such that the reflected light R1 that is the reflected incident light Lᵢₙ strikes the back surface 28b of the cover member 28 substantially perpendicularly, and the reflective surface 24a2 of the mirror element 24 when the mirror element 24 is in the second reflecting position P2 is configured to be substantially parallel to the surface 28a of the cover member 28. Therefore, the reflected light R1 will not tend to be reflected by the back surface 28b of the cover member 28.

That is, the mirror element 24 is arranged such that a third angle β1 formed by a normal line Z1 of the reflective surface 24a1 of the mirror element 24 when the mirror element 24 is in the first reflecting position P1 and a normal line Z3 of the surface 28a of the cover member 28 is greater than a fourth angle β2 formed by a normal line Z2 of the reflective surface 24a2 of the mirror element 24 when the mirror element 24 is in the second reflecting position P2 and the normal line Z3 of the surface 28a of the cover member 28. When the normal line Z3 of the surface 28a of the cover member 28 is aligned with the optical axis X, the mirror element 24 is arranged such that the third angle β1 formed by the normal line Z1 of the reflective surface 24a1 of the mirror element 24 when the mirror element 24 is in the first reflecting position P1 and the optical axis X is greater than the fourth angle β2 (0° in FIG. 8) formed by the normal line Z2 of the reflective surface of the mirror element 24 when the mirror element 24 is in the second reflecting position P2 and the optical axis X.

### Fourth Example Embodiment

As shown in FIG. 7, when the cover member is inclined, the thickness of the light deflecting device in the optical axis direction becomes thicker. The cover member near the optical axis is mainly responsible for the reflected light of the surface 28a of the cover member 28 becoming stray light that largely affects the light distribution pattern. Therefore, the thickness of the overall light deflecting device is able to be suppressed by inclining just a portion of the cover member.

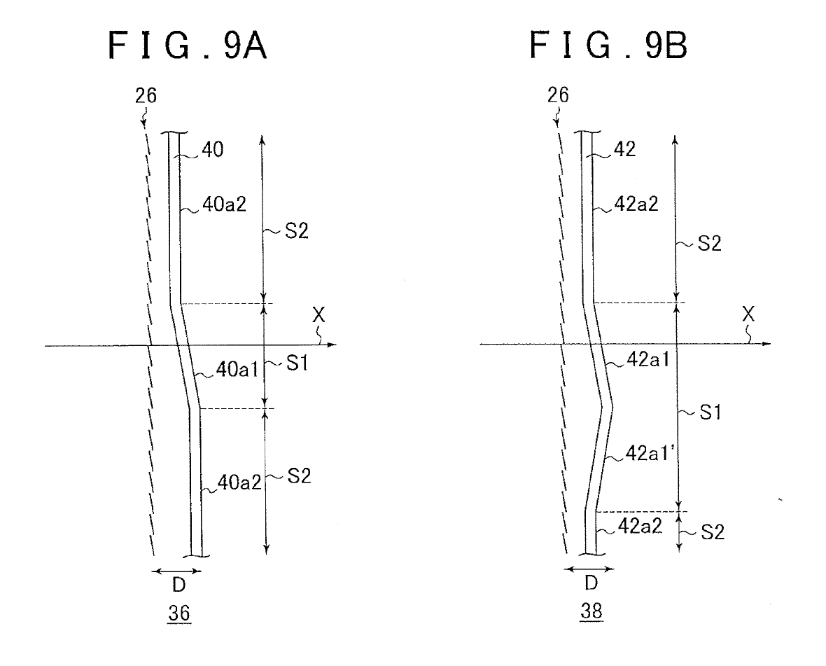

FIG. 9A is a side view of the general structure of a light deflecting device 36 according to a fourth example embodiment of the invention, and FIG. 9B is a side view of the general structure of a light deflecting device 38 according to modified example of the fourth example embodiment.

A cover member 40 of the light deflecting device 36 shown in FIG. 9A is configured such that a first region S1 that includes the optical axis X is a first planar region 40a1 that is inclined with respect to the optical axis X, and a second region S2 on the outside of the first region S1 is a second planar region 40a2 that does not protrude toward the projection optical system side farther than the first planar region 40a1.

Also, a cover member 42 of the light deflecting device 38 shown in FIG. 9B is configured such that a first region that includes the optical axis X is a plurality of first planar regions 42a1 and 42a1′ that are inclined with respect to the optical axis X, and a second region S2 on the outside of the first region S1 is a second planar region 42a2 that does not protrude toward the projection optical system side farther than the first planar region 42a1.

According to the light deflecting devices 36 and 38 having these kinds of structures, the thickness D of the light deflecting device in the optical axis direction is able to be made thinner than it is when the entire cover member is the first planar region (i.e., an inclined surface). When the array direction of the micro-mirror array 26 is perpendicular to the optical axis X as it is in this example embodiment, the cover member 42 of the light deflecting device 38 need only be configured such that the second planar region 42a2 does not to protrude toward the projection optical system side farther than the first planar region 42a1, and such that even if the array direction of the micro-mirror array 26 is inclined with respect to the optical axis X, the height of the second planar region from the plane on which the micro-mirror array 26 is arranged is equal to or less than the height of the first planar region from the plane on which the micro-mirror array 26 is arranged. That is, the cover member 42 of the light deflecting device 38 need only be configured so that the second planar region 42a2 does not protrude toward the surface side farther than the first planar region 42a1.

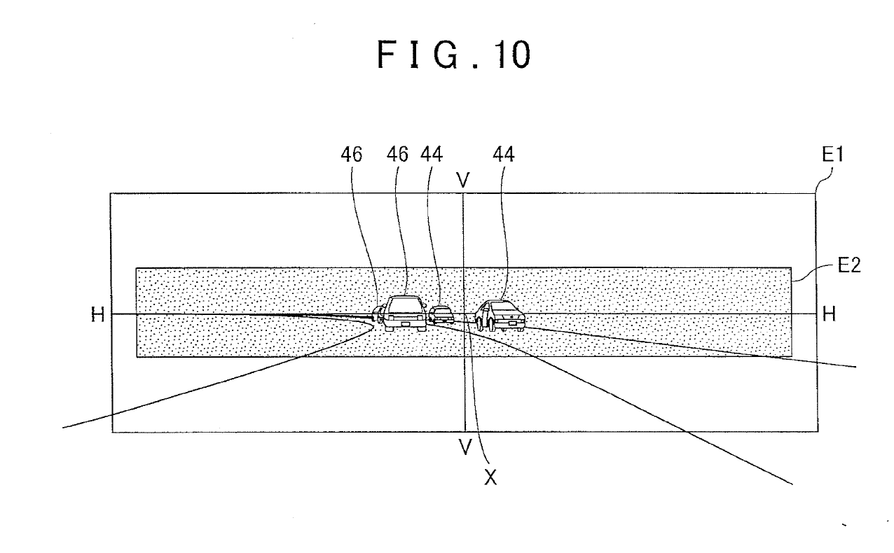

FIG. 10 is a view showing a frame format of a state in which light is radiated in front of a vehicle by a lamp unit provided with the light deflecting device according to the fourth example embodiment. As shown in FIG. 10, when an illuminated area when light is radiated in front of the vehicle using the lamp unit 10 provided with the light deflecting device 36 or the light deflecting device 38 is E1, stray light described above does not pose a problem in the entire illuminated area. The area in which it is particularly necessary to suppress stray light is a partial illuminated area E2 that includes a region near the optical axis X where there is a possibility of imparting glare on an oncoming vehicle 44 or a leading vehicle 46. Therefore, if the first region S1 that includes the optical axis X of the cover member 40 is a first planar region 40a1 that is inclined with respect to the optical axis X, as with the light deflecting device 36 shown in FIG. 9A, for example, the generation of stray light due to the reflected light of the first planar region 40a1 of the cover member 40 is able to be suppressed, and this may be sufficient.

Heretofore, the invention has been described with reference to the various example embodiments above, but the invention is not limited to these example embodiments. That is, any appropriate combination and substitutions of the structures of the example embodiments are also included in the invention. Also, various modifications such as design changes and appropriate rearranging of the order of processes and combinations in the example embodiments based on knowledge of one skilled in the art may also be applied to the example embodiments, and example embodiments that have been thusly modified may also be included in the scope of the invention.

As described above, a lamp unit according to the invention includes a projection optical system, and a light deflecting device that is arranged on an optical axis of the projection optical system, and that selectively reflects light emitted from a light source toward the projection optical system. The light deflecting device according to the invention includes a micro-mirror array that includes a plurality of mirror elements, and a transparent cover member arranged in front of a reflective surface of the micro-mirror array. Each mirror element of the micro-mirror array is configured to be selectively switched between a first reflecting position in which the minor element reflects the light emitted from the light source toward the projection optical system such that the reflected light is effectively used as part of a predetermined light distribution pattern, and a second reflecting position in which the mirror element reflects the light emitted from the light source such that the reflected light is not effectively used. The cover member is configured such that a second angle formed between a reflective surface of the mirror element when the mirror element is in the second reflecting position and a surface of the cover member is smaller than a first angle formed between the reflective surface of the mirror element when the mirror element is in the first reflecting position and the surface of the cover member.

Each mirror element of the micro-mirror array may be arranged such that light reflected by the mirror element in the first reflecting position heads toward the projection optical system, and light reflected by the mirror element in the second reflecting position does not head toward the projection optical system.

The cover member may be configured such that at least a portion of the surface of the cover member is inclined with respect to an array direction of the micro-mirror array. As a result, the second angle formed between the reflective surface of the mirror element when the mirror element is in the second reflecting position and the surface of the cover member is able to be made smaller than the first angle formed between the reflective surface of the mirror element when the mirror element is in the first reflecting position and the surface of the cover member, even without changing the arrangement or structure of the mirror element.

The cover member may be configured such that a first region that includes the optical axis is a first planar region that is inclined with respect to an array direction of the micro-mirror array, and a second region on an outside of the first region is a second planar region that does not protrude toward the surface side farther than the first planar region. Also, the cover member may be configured such that a height of the second planar region from a plane on which the micro-mirror array is arranged is equal to or less than a height of the first planar region from the plane on which the micro-mirror array is arranged. As a result, the thickness of the light deflecting device in the optical axis direction is able to be thinner than it is when the entire cover member is the first planar region.

The mirror element may be arranged such that a third angle formed between the reflective surface of the mirror element when the mirror element is in the first reflecting position and an array direction of the micro-mirror array is greater than a fourth angle formed between the reflective surface of the mirror element when the mirror element is in the second reflecting position and the array direction of the micro-mirror array.

What is claimed is:

1. A lamp unit comprising:
a projection optical system; and
a light deflecting device that is arranged on an optical axis of the projection optical system, and that selectively reflects light emitted from a light source toward the projection optical system, wherein:
the light deflecting device includes a micro-mirror array that includes a plurality of mirror elements, and a transparent cover member arranged in front of a reflective surface of the micro-mirror array;
each mirror element of the micro-mirror array is configured to be selectively switched between a first reflecting position in which the mirror element reflects the light emitted from the light source toward the projection optical system such that the reflected light is effectively used as part of a predetermined light distribution pattern, and a second reflecting position in which the mirror element reflects the light emitted from the light source such that the reflected light is not effectively used; and
the cover member is configured such that a second angle formed between a reflective surface of the mirror element when the mirror element is in the second reflecting position and a surface of the cover member is smaller than a first angle formed between the reflective surface of the mirror element when the mirror element is in the first reflecting position and the surface of the cover member.

2. The lamp unit according to claim 1, wherein each mirror element of the micro-mirror array is arranged such that light reflected by the mirror element in the first reflecting position heads toward the projection optical system, and light reflected by the mirror element in the second reflecting position does not head toward the projection optical system.

3. The lamp unit according to claim 1, wherein the cover member is configured such that at least a portion of the surface of the cover member is inclined with respect to an array direction of the micro-mirror array.

4. The lamp unit according to claim 1, wherein the cover member is configured such that a first region that includes the optical axis is a first planar region that is inclined with respect to an array direction of the micro-mirror array, and a second region on an outside of the first region is a second planar region that does not protrude toward the surface side farther than the first planar region.

5. The lamp unit according to claim 4, wherein the cover member is configured such that a height of the second planar region from a plane on which the micro-mirror array is arranged is equal to or less than a height of the first planar region from the plane on which the micro-mirror array is arranged.

6. The lamp unit according to claim 1, wherein the mirror element is arranged such that a third angle formed between the reflective surface of the mirror element when the mirror element is in the first reflecting position and an array direction of the micro-mirror array is greater than a fourth angle formed between the reflective surface of the mirror element when the mirror element is in the second reflecting position and the array direction of the micro-mirror array.

7. A light deflecting device comprising:
a micro-mirror array that includes a plurality of mirror elements; and
a transparent cover member arranged in front of a reflective surface of the micro-mirror array, wherein:
each mirror element of the micro-mirror array is configured to be selectively switched between a first reflecting position in which the mirror element reflects light emitted from a light source such that the reflected light is effectively used as part of a predetermined light distribution pattern, and a second reflecting position in which the mirror element reflects light emitted from the light source such that the reflected light is not effectively used; and
the cover member is configured such that a second angle formed between a reflective surface of the mirror element when the mirror element is in the second reflecting position and a surface of the cover member is smaller than a first angle formed between the reflective surface of the mirror element when the mirror element is in the first reflecting position and the surface of the cover member.
